(19) United States
(12) Patent Application Publication
(10) Pub. No.: US 2011/0113915 A1
(43) Pub. Date: May 19, 2011

(54) PARALLEL ROBOT

(75) Inventors: GUO-QING ZHANG, Shenzhen City (CN); ZHI-MING ZHAO, Shenzhen City (CN); YONG FENG, Shenzhen City (CN)

(73) Assignees: HONG FU JIN PRECISION INDUSTRY (SHENZHEN) CO., LTD., Shenzhen City (TW); HON HAI PRICISION INDUSTRY CO., LTD., Tu-Cheng (TW)

(21) Appl. No.: 12/650,508

(22) Filed: Dec. 30, 2009

(30) Foreign Application Priority Data
Nov. 18, 2009 (CN) 200910309948.4

(51) Int. Cl. B25J 18/00

(52) U.S. Cl. 74/490.01

(57) ABSTRACT

A parallel robot includes a fixed platform, a movable platform, a plurality of control arms, a rotation arm, a plurality of first actuators, and a second actuator. The control arms are rotatably connected to the fixed platform and the movable platform, respectively. Opposite ends of the rotation arm are universally rotatably connected to the fixed platform and the movable platform, respectively. The first actuators are to respectively move the control arms. The second actuator is to drive the rotation arm to rotate around the center axis of the rotation arm. Each control arm includes a first transmission unit including a transmission member. Each first actuator includes a transmission gear to engage the transmission member of the control arm.

### BACKGROUND

1. Technical Field

The present disclosure generally relates to parallel robots, and particularly, to a parallel robot having a simplified structure.

2. Description of Related Art

Parallel robots have advantages of stability, load-bearing, favorable weight to load ratio, and dynamic characteristics among other things. As parallel robots and series robots cooperate, they may be used in many fields.

Some parallel robots include a fixed platform (also known as a base), a movable platform, a shaft, and three control arms. The shaft and the control arms connect the movable platform to the fixed platform. Each control arm includes an actuator mounted on the fixed platform, a first linking bar hinged to the movable platform, and a second linking bar hinged between the actuator and the first linking bar. The actuator includes a servo motor and a decelerator. The decelerator connects the servo motor and the first linking bar to adjust a rotation speed of the first linking bar. However, the decelerator has a high cost. In addition, the decelerator has complex construction and so is difficult to maintain.

Therefore, a parallel robot is desired to overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an assembled view of a parallel robot of an embodiment of the disclosure, the parallel robot including a fixed platform, a movable platform, three control arms, and a rotation arm.

FIG. 2 is an exploded, isometric view of the parallel robot of FIG. 1.

FIG. 3 is an exploded, isometric view of part of one control arm of the parallel robot of FIG. 1.

FIG. 4 is an enlarged view of region IV of FIG. 2.

### DETAILED DESCRIPTION

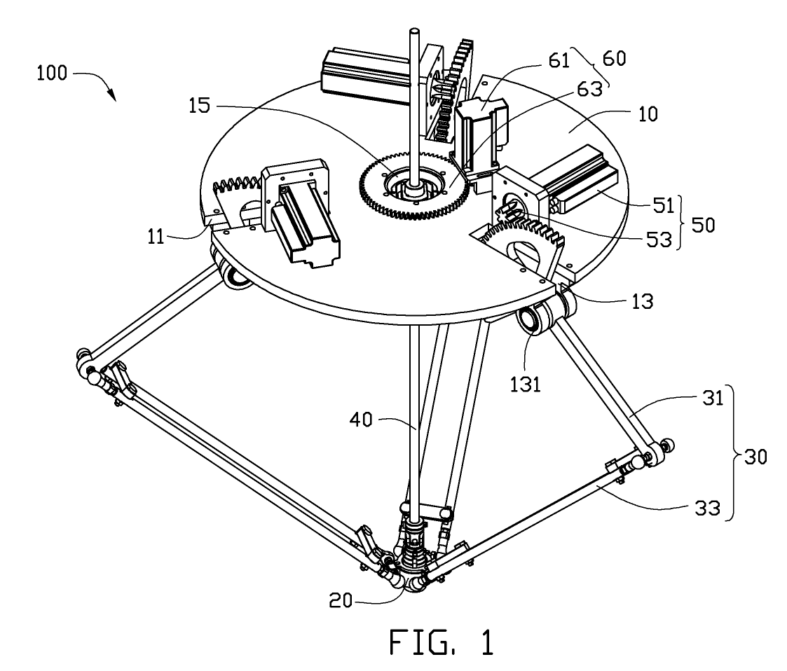

Referring to FIG. 1, an embodiment of a parallel robot 100 is shown. The parallel robot 100 includes a fixed platform 10, a movable platform 20, three control arms 30 rotatably connecting the fixed platform 10 to the movable platform 20, and a rotation arm 40. The parallel robot 100 further includes three first actuators 50 and a second actuator 60 mounted on the fixed platform 10.

The fixed platform 10 can be substantially circular-shaped. The fixed platform 10 defines three cutouts 11 at a periphery thereof and a mounting hole 15 in a center thereof. The cutouts 11 may be symmetrically arranged. The fixed platform 10 includes three connecting portions 13 formed adjacent to the cutouts 11. Each connecting portion 13 includes a support bearing 131.

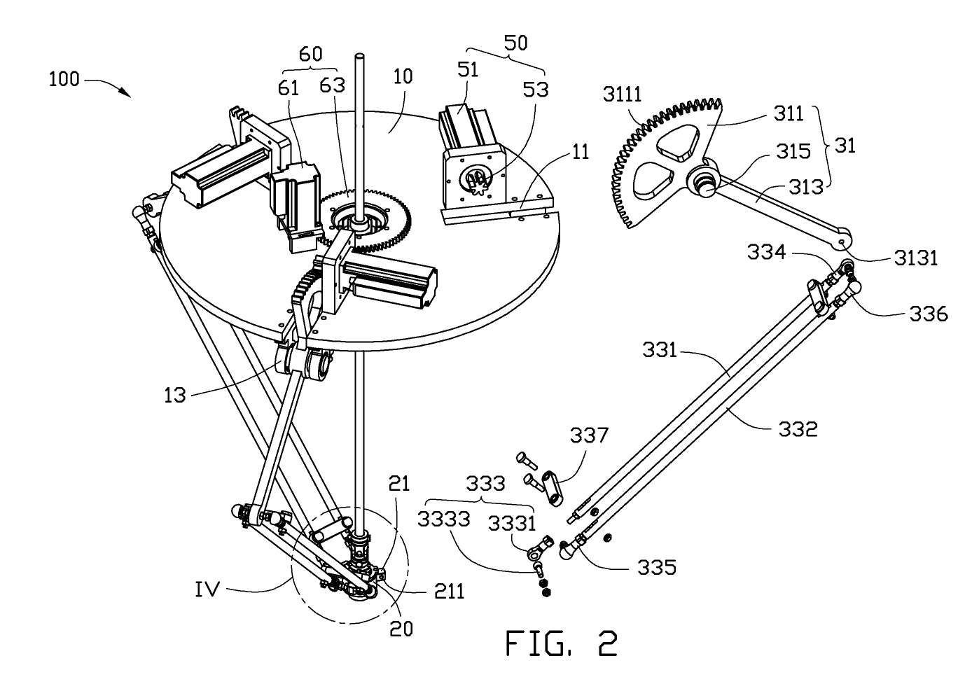

Referring to FIG. 1 and FIG. 2, the movable platform 20 includes three connecting portions 21 each defining a connecting hole 211.

Each control arm includes a first transmission unit 31 and a second transmission unit 33. One end of the first transmission unit 31 is connected to the connecting portion 13 of the fixed platform 10, and an opposite end of the first transmission unit 31 is connected to the second transmission unit 33. One end of the second transmission unit 33 is connected to the connecting portion 21 of the movable platform 20.

The first transmission unit 31 includes a transmission member 311, a bar 313, and a rotating shaft 315. The transmission member 311 is a fan-shaped gear including a plurality of teeth 3111 formed at a periphery of the transmission member 311. The bar 313 is formed at a center of the transmission member 311. The rotating shaft 315 runs through the transmission member 311 and an end of the bar 313, thus connecting the transmission member 311 to the bar 313. The bar 313 defines a connecting hole 3131 at an end opposite the end connected to the transmission member 311. A center angle of the fan-shaped transmission member 311 is determined by a desired range of motion of the movable platform 20.

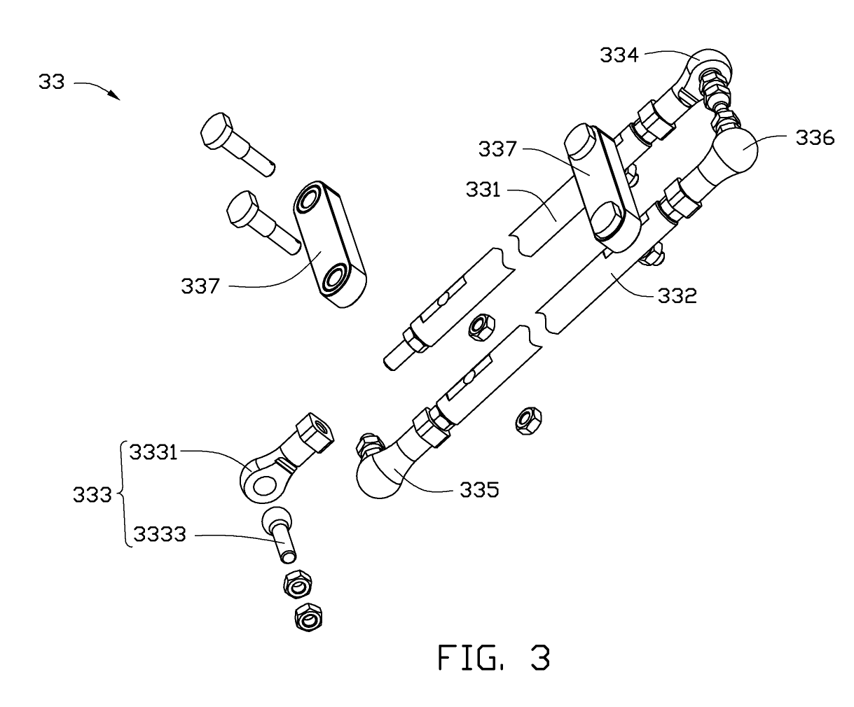

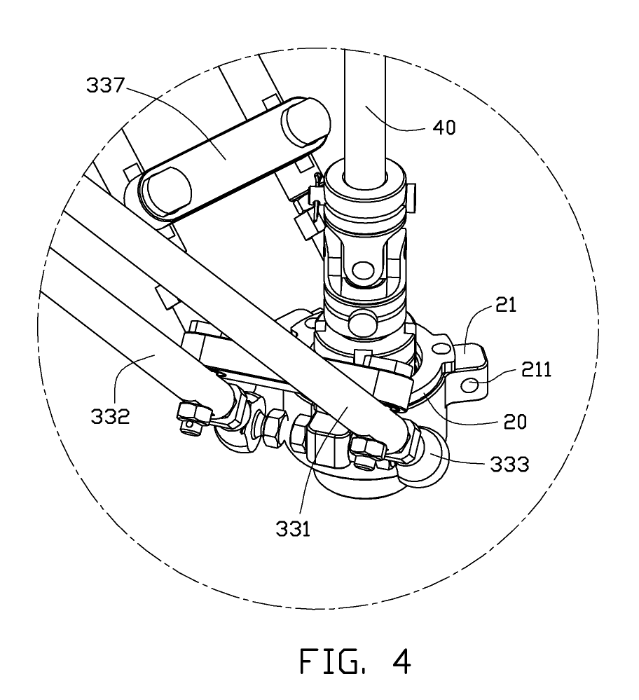

Referring to FIG. 2 through FIG. 4, the second transmission unit 33 has a four-bar linkage structure. The second transmission unit 33 includes a first bar 331, a second bar 332, a first pivot unit 333, a second pivot unit 334, a third pivot unit 335, a fourth pivot unit 336, and two connecting bars 337 connecting the first bar 331 and the second bar 332. Each of the first, second, third, fourth pivot units 333, 334, 335, 336 includes a first rotating member 3331 and a second rotating member 3333 universally rotatably connected to each other. That is, the first, second, third, fourth pivot units 333, 334, 335, 336 are ball hinges. The first rotating members 3331 of the first pivot unit 333 and the second pivot unit 334 are connected at opposite ends of the first bar 331. The first rotating members 3331 of the third pivot unit 335 and the fourth pivot unit 336 are connected at opposite ends of the second bar 332. The second rotating members 3333 of the first pivot unit 333 and the third pivot unit 335 are connected to the connecting portion 21 of the movable platform 20. The second rotating members 3333 of the second pivot unit 334 and the fourth pivot unit 336 are connected to the connecting hole 3131 of the first transmission unit 31, so as to be movably coupled to the first transmission unit 31. The connecting bars 337 are slidable on the first bar 331 and the second bar 332.

Each first actuator 50 is mounted at a side of one corresponding cutout 11 to drive the corresponding control arm 30 to move. The first actuator 50 includes a motor 51 and a transmission gear 53 axially connected to the motor 51. In the illustrated embodiment, the transmission gear 53 is a gear to engage the teeth 3111 of the transmission member 311. A diameter of the transmission gear 53 is smaller than the diameter of the transmission member 311, therefore the engagement of the transmission gear 53 and the transmission member 311 performs a deceleration function.

The second actuator 60 is mounted adjacent to the mounting hole 15 to drive the rotation arm 40 to rotate around a center axis of the rotation arm 40. The second actuator 60 includes a motor 61 and a first gear (not shown) and a second gear 63 engaging with the first gear. The second gear 63 is connected to the rotation arm 40 to drive the rotation arm 40.

Referring to FIG. 1 through FIG. 4, during assembly of the parallel robot 100, the first actuators 50 and the second actuator 60 are mounted on the fixed platform 10. Opposite ends of each rotating shaft 315 are received in the support bearings 131 of one corresponding connecting portion 13 of the fixed platform 10, such that the first transmission units 31 are rotatably connected to the fixed platform 10. The transmission members 311 protrude in the cutouts 11 to engage with the transmission gears 53 of the first actuators 50. Each second transmission unit 33 is rotatably connected to the corresponding first transmission unit 31 via inserting the second rotating members 3333 of the second pivot unit 334 and the fourth pivot unit 336 through the connecting hole 3131 of the bar 313. Each second transmission unit 33 is rotatably connected to the movable platform 20 via inserting the second rotating members 3333 of the first pivot unit 333 and the third pivot unit 335 through the connecting hole 211 of the corresponding connecting portion 21. One end of the rotation arm 40 is universally rotatably connected to the movable platform 20, and an opposite end of the rotation arm 40 is universally rotatably connected to the fixed platform 10 by extending through the mounting hole 15.

During operation, the first actuators 50 rotate the first transmission units 31, thus moving the second transmission units 33 in three axes. Therefore, the movable platform 20 can move in three axes with respect to the fixed platform 10. It can be understood that the movable platform 20 may only move in one, two, or all three of the described axes. The second actuator 60 rotates the first gear (not shown) and the second gear 63, thus rotating the rotation arm 40. As such, an end of the rotation arm 40 not only moves on the three axes, but also can rotate around the center axis thereof.

A rotation speed is decelerated by means of engagement of the transmission member 311 and the transmission gear 53; therefore, no additional members, such as a gear box, with complex structures are needed. Therefore, the parallel robot 100 has lower manufacturing cost and lower maintaining cost. In addition, compared with circular gears, the fan-shaped transmission member 311 occupies less space and needs less driving force, and has a smaller rotational inertia. Therefore, transmission precision is improved. Alternatively, the transmission member 311 may be other than fan-shaped, such as circular. The number of the control arms 30 may also be only two or more than three.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A parallel robot, comprising:
a fixed platform;
a movable platform;
a plurality of control arms rotatably connected to the fixed platform and the movable platform, respectively;
a rotation arm with opposite ends universally rotatably connected to the fixed platform and the movable platform, respectively, and the rotation arm being rotatable around a center axis thereof;
a plurality of first actuators to respectively move the control arms; and
a second actuator to drive the rotation arm to rotate around the center axis of the rotation arm;
wherein each control arm comprises a first transmission unit including a transmission member, each first actuator comprises a transmission gear to engage the transmission member of the control arm.

2. The parallel robot of claim 1, wherein the transmission member is fan-shaped.

3. The parallel robot of claim 1, wherein the transmission member is a gear, a diameter of the transmission member of the control arm is larger than a diameter of the transmission gear of the first actuator.

4. The parallel robot of claim 1, wherein the control arm further comprises a second transmission unit with an end rotatably connected to the first transmission unit and an opposite end of the second transmission unit rotatably connected to the movable platform.

5. The parallel robot of claim 4, wherein the fixed platform comprises a plurality of connecting portions; the first transmission unit further comprises a bar and a rotating shaft running through the transmission member of the first transmission unit and an end of the bar; the rotating shafts of the first transmission units of the control arms rotatably engage the connecting portions of the fixed platform.

6. The parallel robot of claim 5, wherein the fixed platform defines a plurality of cutouts, the first actuators and the second actuator are mounted on the fixed platform; the transmission members of the control arms protrude in the cutouts, respectively.

7. The parallel robot of claim 5, wherein each connecting portion comprises a support bearing to rotatably receive the rotating shaft.

8. The parallel robot of claim 5, wherein the second transmission unit of each control arm comprises a first bar, a second bar, a first pivot unit, a second pivot unit, a third pivot unit, a fourth pivot unit, and two connecting bars connecting the first bar and the second bar; the first and third pivot units rotatably connect the first bar and the second bar to the movable platform; the second and fourth pivot units rotatably connect the first bar and the second bar to the first transmission unit.

9. The parallel robot of claim 8, wherein each of the first, second, third, and fourth pivot units comprises a first rotating member and a second rotating member universal-rotatably connected to each other; the first rotating members of the first pivot unit and the second pivot unit are connected at opposite ends of the first bar; the first rotating members of the third pivot unit and the fourth pivot unit are connected at opposite ends of the second bar; the second rotating members of the first pivot unit and the third pivot unit are connected to the connecting portion of the movable platform; the second rotating members of the second pivot unit and the fourth pivot unit are connected to the connecting portion of the fixed platform.

10. The parallel robot of claim 1, wherein each of the first actuators further comprises a motor to rotate the transmission gears of the first actuator.

11. The parallel robot of claim 1, wherein the second actuator comprises a motor and a second gear rotated by the motor, the motor is mounted on the fixed platform; the rotation arm is connected to the second gear, thus rotated by the motor.
